(19) United States
(12) Patent Application Publication
(10) Pub. No.: US 2026/0334395 A1
(43) Pub. Date: Oct. 29, 2026

(54) MODULAR HYDROPONIC SYSTEM

(71) Applicants: Austin Nestor Montero Quintana, Lake Forest, CA (US); Refugio J. Crudi, Lake Forest, CA (US)

(72) Inventors: Austin Nestor Montero Quintana, Lake Forest, CA (US); Refugio J. Crudi, Lake Forest, CA (US)

(21) Appl. No.: 19/277,239

(22) Filed: Jul. 22, 2025

Related U.S. Application Data
(60) Provisional application No. 63/796,905, filed on Apr. 29, 2025.

(51) Int. Cl. A01G 31/06

(52) U.S. Cl. CPC A01G 31/06

(57) ABSTRACT

A modular hydroponic system is disclosed. The modular hydroponic system leverages inverted reservoirs for gravitational irrigation and passive pressure equalization. The inverted reservoirs are filled with water through a spout when in an upright position, then inverted and slotted onto a main reservoir of the hydroponic system. The modular hydroponic system also includes one or more grow baskets that can be slotted onto the main reservoir of the hydroponic system. Each grow basket includes a water-permeable layer for holding growth medium for a plant. The water-permeable layer may include holes, through which roots of the plant may extend downwards in the main reservoir. The modular hydroponic system may further include an outer shell for blocking incident light on the main reservoir, thereby reducing algae growth in the main reservoir. The outer shell may be coated with a material that is non-transmissive to light, thereby providing the light bocking effect. The modular hydroponic system may include a distillation chamber to store non-potable water (such as saltwater or contaminated water), insulating space configured to reduce thermal transfer, an evaporation chamber and vents for cooling certain reservoirs.

### CROSS-REFERENCE TO RELATED APPLICATIONS

This application claims the benefit of and priority to U.S. Provisional Application No. 63/796,905 filed on Apr. 29, 2025, which is incorporated by reference in its entirety.

### BACKGROUND

Ensuring a sustainable supply of fresh vegetables is vital for our society. However, projections on climate for the coming decades indicate an increasing prevalence of extreme outdoor conditions. Climate change is already impacting crop production worldwide, posing risks such as flooding, droughts, and plant epidemics that can disrupt the availability of fresh vegetables to certain populations. In response to these challenges, there is a growing need for alternative cultivation methods that can thrive amidst changing climatic conditions.

Indoor horticulture has emerged as a promising solution, offering a controlled environment that can withstand extreme outdoor conditions. However, traditional indoor cultivation options, such as laboratory facilities or greenhouses, come with limitations. These facilities require time-consuming construction and multiple structures to sufficiently supplement a population's food needs in case of a catastrophe. Additionally, the construction of dedicated agricultural facilities competes with traditional outdoor agriculture, leaving little room for preparation when extreme weather conditions eventually halt production. This limitation hampers the ability to ensure a continuous supply of fresh vegetables in the face of future disruptions.

To overcome these challenges, there is a need for a cost-effective and readily available solution that provides sealed facilities protected from extreme weather conditions, while also offering constant access to water, electricity, and sunlight for a successful horticultural setup. Remarkably, such facilities already exist worldwide in the form of houses, many of which are equipped with their own temperature control systems, such as air conditioners. Houses possess all the necessary features for horticulture and can even provide high concentrations of carbon dioxide emitted by the inhabitants, which has been observed to increase plant production. The only missing requirement for houses to support plant cultivation is the provision of nutrients, which can be supplied through soil or hydroponic solutions. Nevertheless, many homes are already equipped for the provision of natural light, i.e., sunlight streaming through windows.

Windowsills within houses remain an underutilized space for horticulture despite their potential. These windowsills provide natural isolation from unfavorable outdoor conditions, including excessive heat, cold, and plant diseases. As a result, windowsills serve as ideal supports for horticultural systems. However, to date, there is a lack of specifically designed systems that effectively harness this area for cultivating edible plants.

### SUMMARY

While previous hydroponic systems aimed at household use have been developed, none have provided the configuration to effectively cultivate plants on small windowsills or accommodate the growth of tuberous and taproot plants like potatoes and carrots. Despite the potential of gravity-based irrigation to reduce bulkiness, challenges arise in windowsill settings, including overheating and rapid evaporation due to sunlight exposure.

The modular hydroponic system described herein addresses these issues comprehensively. An inverted reservoir features a single opening that leverages gravity to break water tension, facilitating drainage and air entry. This eliminates the need for removable parts in the reservoir, simplifying refilling through the same hole used for drainage into the lower container. Additionally, the inverted reservoir may be placed over the main reservoir without spillage by blocking the hole with a finger, ensuring a straightforward system. A valve or stop-gate can be included inside the inverted reservoir to reduce spillage even further. The inverted reservoir provides for gravity irrigation and natural pressure equalization, automatic water level regulation, and minimizing maintenance.

Furthermore, the hydroponic system includes a grow basket with a wide bottom opening and a deep lower liquid reservoir for unobstructed root growth, particularly for tuberous plants like potatoes and taproots like carrots. The grow basket can easily be coupled to and/or decoupled from the main reservoir, empowering the ability to transplant the grow basket from one system to another.

Moreover, in some embodiments, the hydroponic system includes a main reservoir sized to fit any combination of modular units. The main reservoir can hold one or more grow baskets, one or more inverted reservoirs, or some combination thereof. Our solution to overwatering concluded with the creation of an air chamber between the lower and upper containers.

The system may be optimized for existing window spaces. In one or more embodiments, the system may be custom manufactured to fit different spaces. A manufacturing system may leverage a 3D printer for forming components of the hydroponic system. This modularity of the system can satisfy various space constraints, while maintaining optionality for future expansion and user-friendly adaptability.

This invention introduces a compact hydroponic system—a rectangular pot employing gravity irrigation and natural pressure equalization to ensure consistent water levels for seed germination and plant growth. The system is particularly advantageous in confined spaces like windowsills, offering versatility through modular components. In some embodiments, the system is further enhanced to enable the use of non-potable water (such as saltwater or contaminated water), through evaporation and subsequent condensation. This modular system overcomes the challenges in indoor horticulture, providing a simple and adaptable solution for hydroponic cultivation.

The modular hydroponic system is capable of growing any number of plants. This includes ten herb varieties, including: Echinacea (Echinacea purpurea), Epazote (Dysphania ambrosioides), Parsley (Petroselinum crispum), Lemon Balm (Melissa officinalis), Spearmint (Mentha spicata), Thyme (Thymus vulgaris), Papalo (Porophyllum ruderale), Chamomile (Matricaria recutita), Oregano (Origanum vulgare), and Basil (Ocimum basilicum). This also includes legumes, such as: Alfalfa (Medicago sativa). This also includes tuberous vegetables, such as: Leek (Allium ampeloprasum var. porrum), Potato (Solanum tuberosum). This also includes ornamental plants, such as: Cosmos (Cosmos bipinnatus). This also includes vegetables, such as: Celery (Apium graveolens), Lettuce (Lactuca sativa), Arugula (Eruca sativa), and Carrot (Daucus carota subsp. sativus). The ability to germinate and nurture various species, including carrots, positions this system as a solution for indoor gardening, particularly in urban settings where space is limited.

In certain scenarios, access to clean, potable water may also be limited due to environmental factors or infrastructure failure. To address this, additional embodiments of the system enable the use of non-potable water sources, such as saltwater or contaminated water, by incorporating design modifications that promote condensation and water recovery features. These modifications allow the system to distill water through passive or assisted evaporation and condensation, providing a sustainable method for growing plants even under conditions where potable water is unavailable.

### BRIEF DESCRIPTION OF THE DRAWINGS

FIG. 1A is a backside perspective view of a modular hydroponic system, according to one or more embodiments.

FIG. 1B is a backside view of the modular hydroponic system of FIG. 1A, according to one or more embodiments.

FIG. 2 is a backside view of a modular hydroponic system with a half-sized outer shell, according to one or more embodiments.

FIG. 3 is a backside view of a modular hydroponic system without an outer shell, according to one or more embodiments.

FIG. 4 is a backside view of a modular hydroponic system with a single inverted reservoir, according to one or more embodiments.

FIG. 5 is a backside view of a modular hydroponic system with multiple grow baskets, according to one or more embodiments.

FIG. 6 is a perspective view of a modular hydroponic system without an inverted reservoir, according to one or more embodiments.

FIG. 7 is a backside perspective view of an outer shell, according to one or more embodiments.

FIG. 8 is a backside perspective view of an outer shell with a back panel, according to one or more embodiments.

FIG. 9 is a close-up perspective view of an inverted reservoir with spout upright, according to one or more embodiments.

FIG. 10 is a close-up perspective view of a grow basket, according to one or more embodiments.

FIG. 11A is a first image of the modular hydroponic system of FIGS. 1A & 1B, according to one or more example implementations.

FIG. 11B is a second image of the modular hydroponic system of FIGS. 1A & 1B, according to one or more example implementations.

FIG. 12A is a side view of a modular hydroponic system with a distillation setup, according to one or more embodiments.

FIG. 12B is a perspective view of the modular hydroponic system with the distillation setup of FIG. 12A, according to one or more embodiments.

FIG. 13 is a side view of a modular hydroponic system with a distillation setup, according to one or more embodiments.

FIG. 14 is a side view of a modular hydroponic system with a distillation setup, according to one or more embodiments.

FIG. 15A is a perspective view of an outer reservoir for the modular hydroponic system of FIG. 14, according to one or more embodiments.

FIG. 15B is a side view of the outer reservoir of FIG. 15A, according to one or more embodiments.

FIG. 15C is a top perspective view of the outer reservoir of FIG. 15A, according to one or more embodiments.

FIG. 16 is a perspective view of the main reservoir for the modular hydroponic system of FIG. 14, according to one or more embodiments.

FIG. 17A is a top perspective view of a circular grow basket, according to one or more embodiments.

FIG. 17B is a top perspective view of a moisture retainer couplable to a top of the circular grow basket, according to one or more embodiments.

FIG. 17C is a top perspective view of the circular grow basket with the moisture retainer coupled atop, according to one or more embodiments.

### DETAILED DESCRIPTION

A modular hydroponic system has a main reservoir with a slim profile. The modular hydroponic system includes one or more grow baskets that can be slotted onto the main reservoir of the hydroponic system. Each grow basket may include a water-permeable layer for holding growth medium for a plant. The water-permeable layer may include holes, through which roots of the plant may extend downwards in the main reservoir. In addition, a non-permeable substrate can be used within the basket. This substrate can be elastic or moldable, such as silicone in the form of spheres or shaped to fit the basket and change its shape as the plant roots develop. The modular hydroponic system may include one or more inverted reservoirs for gravitational irrigation and passive pressure equalization. The inverted reservoirs are filled with water through a spout when in an upright position, then inverted and slotted onto a main reservoir of the hydroponic system. The modular hydroponic system may further include an outer shell for blocking incident light on the main reservoir, thereby reducing algae growth in the main reservoir. The outer shell may be coated with a material that is non-transmissive to light, thereby providing the light blocking effect.

The modular hydroponic system can be compact, making it suitable for placement in small spaces, such as interior windowsills. It can have rectangular angles in all components of the system, improving the use of limited space for water reservoirs. Furthermore, the rectangular angles enable the stacking of multiple units in either a row or a grid configuration. This provides modularity in which units can be paired together in the hydroponic system.

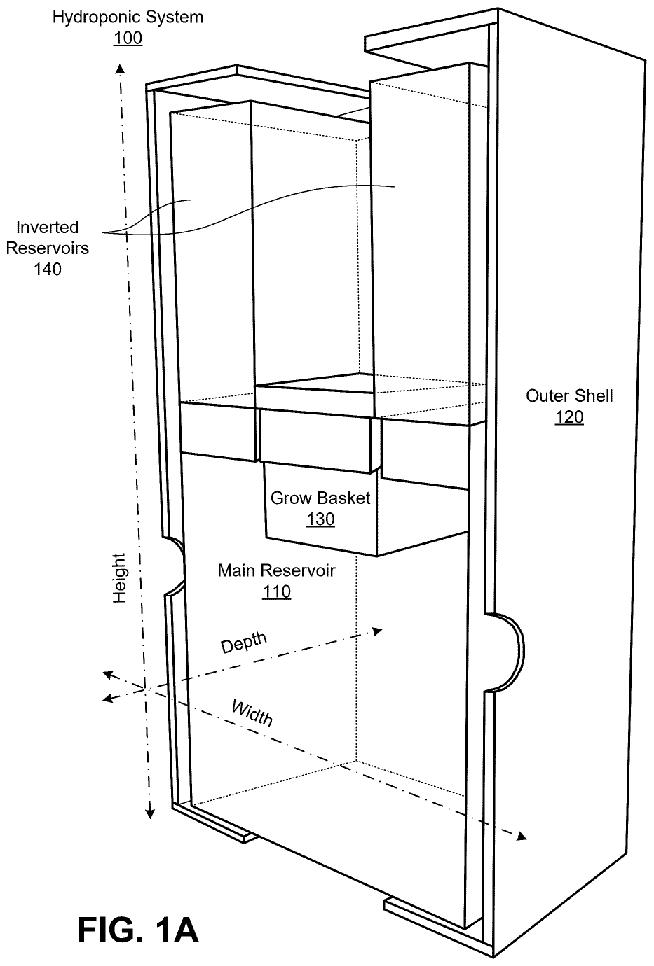

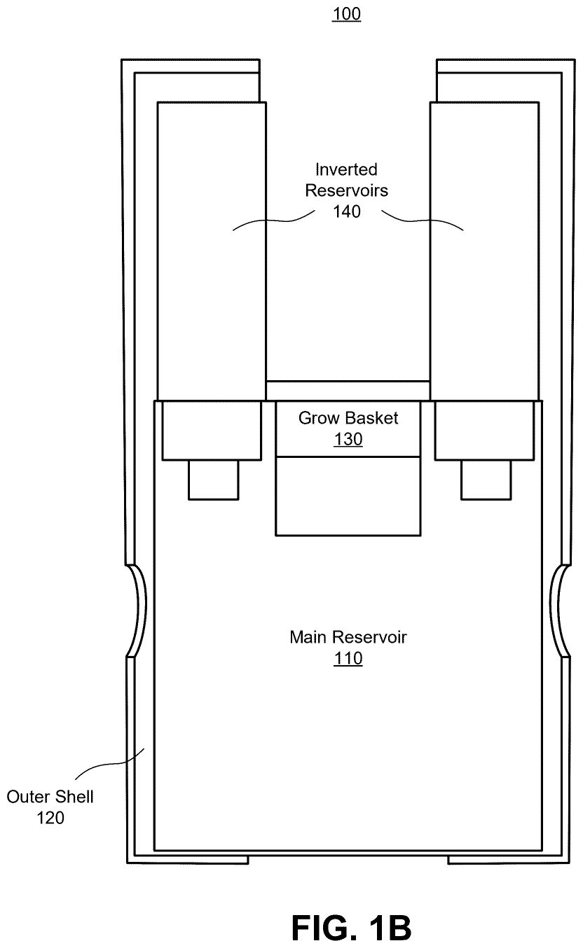

FIG. 1A is a backside perspective view of a hydroponic system 100, according to one or more embodiments. The hydroponic system 100 includes a main reservoir 110 slotted into an outer shell 120. The main reservoir 110 may hold one or more grow baskets 130, one or more inverted reservoirs 140, or some combination thereof. In other embodiments, the main reservoir 110 may be sized to accommodate any number of inverted reservoirs 140 and any number of grow baskets 130.

The main reservoir 110 is a container configured to hold fluid for nourishment of a plant. The main reservoir 110 may have a slim profile, i.e., a small depth, measured from a front face to a back face, e.g., 1 inch, 2 inches, 3 inches, 4 inches, 5 inches, or more. A height of the main reservoir 110 constrains root growth of the plant(s) in the grow basket(s). A reservoir with a higher height can empower longer root growth. A reservoir with a lower height can maintain a more compact profile. The reservoir height may be 3 inches, 4 inches, 5 inches, 6 inches, 7 inches, 8 inches, 9 inches, 10 inches, 11 inches, 12 inches, or more. The width of the main reservoir 110 (measured from side wall to side wall) affects how many components can be coupled to the main reservoir 110. For example, if each unit's width was similar (e.g., 2 inches) and if the width of the main reservoir 110 was three times the each unit's width (e.g., 6 inches), then the main reservoir could hold three units. A unit could be a grow basket 130, an inverted reservoir 140, or another component.

The principle of gravity irrigation can be extended for use with an external reservoir. This external reservoir may be mounted on a vertical surface, such as a wall, or positioned on the same horizontal surface as the cultivation pots. However, it still will have to be elevated relative to the pots to enable gravity flow. A fluid distribution network, such as a series of hoses, may connect the external supply reservoir to an inlet port of the hydroponic system. These inlet ports may be configured to interface with the main reservoir, or the inverted reservoir. Utilizing the same principle of gravity irrigation and maintaining appropriate pressure equalization within the system, the external reservoir is capable of replenishing the fluid level. In one or more embodiments, the external reservoir may be connected to a plurality of hydroponic systems for replenishing fluid across systems.

In one or more embodiments, an artificial light may be slotted or attached to the upper part of the shell, the main reservoir, the basket, or to a base. The artificial light may be battery powered or may include a plug for connection to an electrical source (e.g., a USB, a two-pronged or three-pronged electrical plug for connecting to a wall outlet, etc.).

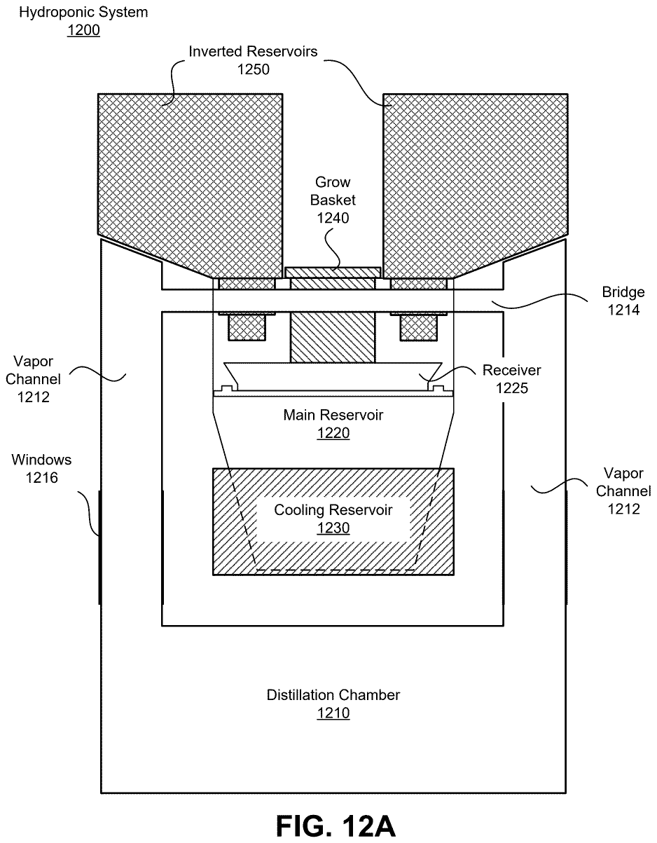

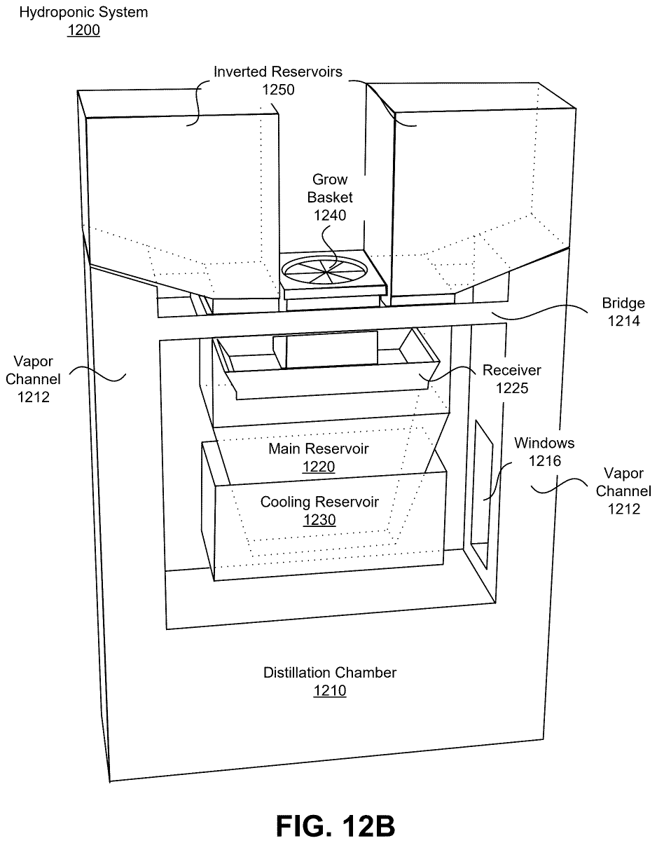

In one or more embodiments, the system may include a distillation chamber configured for distillation and provision of water, e.g., from non-potable water, such as saltwater or contaminated water. This distillation chamber may be positioned externally relative to the primary cultivation components (e.g., the basket or main reservoir). In one or more embodiments, the distillation chamber may be situated internally, such as within the inverted reservoir, in a manner that facilitates water vapor transfer to the other reservoirs. Fluid communication via a condensation canal provided between the distillation chamber and the other reservoirs supplies the grow basket with water. Water evaporates, enabling water vapor from the source water to transfer to the other reservoirs and condense, thereby generating potable water for plant cultivation. Furthermore, the design may incorporate an insulating space, such as an air gap, an air chamber or a vacuum insulation layer, disposed between the distillation chamber and the other components (e.g., the main reservoir or the inverted reservoirs) to reduce heat transfer and enhance condensation efficiency. Vents may be located on the distillation chamber, configured to allow the ingress of outside air. This airflow is directed towards the main reservoir to facilitate convective heat dissipation. Additionally, the system may include an evaporation chamber configured to reduce the temperature of the main reservoir. This evaporation chamber may be located external to, and is fluidly isolated from, the main reservoir. However, the evaporation chamber is positioned in thermal communication with the main reservoir to facilitate heat transfer therebetween. The evaporation chamber contains its own quantity of water and comprises an opening configured for the escape of water vapor from this contained water. Evaporation of water from the evaporation chamber provides cooling to the main reservoir through evaporative heat dissipation facilitated by the thermal communication. Further details of the distillation configuration are described in FIGS. 12-17.

The main reservoir 110 may be rectilinear in shape. In such embodiments, the main reservoir 110 may be formed from five planar surfaces, i.e., a bottom wall, a front wall, a back wall, and two side walls. The top face may be opened, such that the units (inverted reservoirs, grow baskets, etc.) of the hydroponic system 100 may rest on one or more top edges of the front wall, the back wall, and the two side walls. A distance between the front wall and the back wall sets the depth of the main reservoir. A depth of the units corresponds to or matches the depth of the main reservoir 110. Each unit includes one portion with a depth that is less than the depth of the main reservoir 110, such that that portion can fit into the main reservoir 110, whereas another portion of each unit has a depth that is greater than the depth of the main reservoir 110, such that the other portion can sit atop the top edges of the front wall and the back wall of the main reservoir 110.

In other embodiments, the main reservoir 110 may be of a differing shape. For example, in one or more embodiments, the main reservoir 110 may have a non-uniform cross-sectional area from top to bottom. In such embodiments, the depth of the top face of the main reservoir 110, i.e., the opening, still guides the sizing of the depth of the units, such that the units can sit atop the edges of the front wall and the back wall. In other embodiments, the main reservoir 110 may include one or more top surfaces coupled to the front wall, the back wall, and/or the side walls. The top surfaces may define an opening to the main reservoir 110, with a depth of the opening that determines a sizing of the depth of the units. In such embodiments, the one or more units may rest, in part, on one or more of the top surfaces, e.g., in conjunction with a top edge of another wall. In one or more embodiments, the one or more units may include a clip or a hook that sits on the top edge of one of the vertical walls (i.e., the front wall, the back wall, or a side wall).

In one or more embodiments, the main reservoir 110 is composed of a light-transmissive material. In some example implementations, the light-transmissive material is at least 50%, 60%, 70%, 80%, or 90% transmissive. The light-transmissive material may be thermoplastic, glass, crystal, etc. Being light-transmissive, the main reservoir 110 can provide quick indication to a user of the hydroponic system 100. The user could view a water level in the main reservoir 110, any contaminants in the main reservoir 110, growth progress of a plant in a grow basket 130, etc.

In other embodiments, the main reservoir 110 may be composed of a non-transmissive material. In some example implementations, the non-transmissive material is less than 50%, 40%, 30%, 20%, or 10% transmissive. The light-transmissive material may be thermoplastic, metal, etc. In some embodiments, the walls of the main reservoir 110 may be covered with a non-transmissive material, e.g., paint, tape, etc. Preventing light incident on the main reservoir 110 may aid in preventing algae growth. It may also help to minimize heating of the fluid in the main reservoir 110, which can help to mitigate evaporation of fluid from the main reservoir. Mitigation of fluid evaporation can prolong frequency of refilling of the reservoir (i.e., either through direct refilling of the main reservoir, or through gravitational irrigation via one or more inverted reservoirs).

The outer shell 120 also blocks light from being incident on the main reservoir 110. The outer shell 120 may be sized to provide cover to at least one wall of the main reservoir 110. In one or more embodiments, the outer shell 120 may be sized to have a depth and a width matching a profile of the main reservoir 110. In the embodiment shown in FIG. 1A, the outer shell 120 may be sized to fit the main reservoir 110 with the inverted reservoirs 140. The height of the outer shell 120 may be greater than a height of the main reservoir 110 with the inverted reservoirs 140 affixed atop the main reservoir 110. In other embodiments, (i.e., a half-sized configuration), the height of the outer shell 120 may match the height of the main reservoir 110. In one or more embodiments, the main reservoir 110 is slotted into the outer shell 120. In such embodiments, the outer shell 120 includes a base, two side panels, and a front panel. The main reservoir 110 may sit atop the base. The outer shell 120 may be sized such that the main reservoir 110 and outer shell 120 may form a flush surface, when the two components are fitted together. In some embodiments, the outer shell 120 may be coupled to the walls of the main reservoir 110 leveraging another mechanism, e.g., complementary magnets disposed on the main reservoir 110 and the outer shell 120 for snapping the outer shell 120 onto the main reservoir 110, etc. The outer shell and the walls of the main reservoir (either the vertical walls or its base) can possess an interlocking mechanism, a snap-fit mechanism, a bayonet mount, a latch mechanism, or a dovetail joint to attach the pot to the outer shell. These attaching mechanisms may be used for installing the hydroponic system 100 to a boat, a car, or any moving surface and avoid the system moving or falling out of place. In addition, the outer shell and/or the main reservoir may have any of the aforementioned mechanisms for attaching the system to a wall.

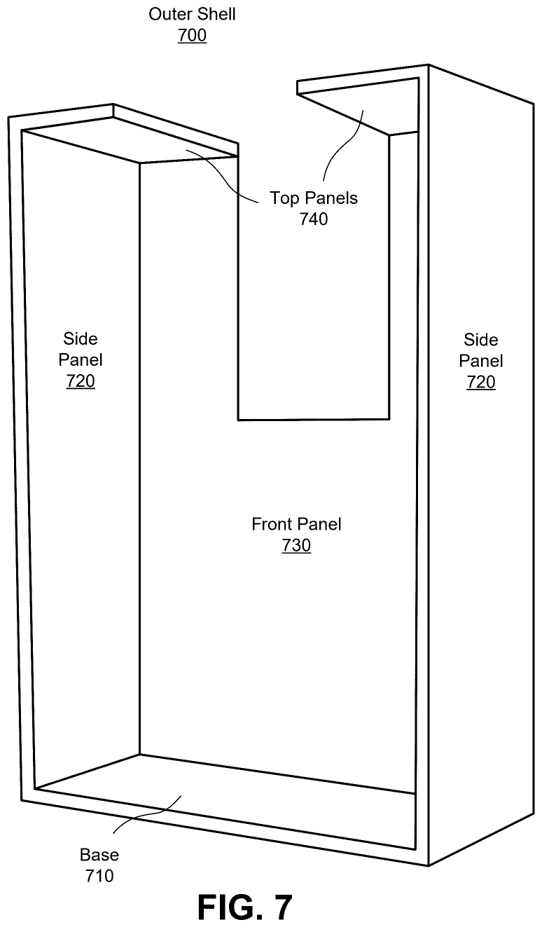

The outer shell 120 is composed of a non-transmissive material. In some implementations, the outer shell 120 may be composed of a thermoplastic that is non-transmissive. In other implementations, the outer shell 120 may be composed of a partially transmissive thermoplastic that is coated with a non-transmissive layer (e.g., paint, tape, etc.). The outer shell 120 may include one or more grooves cut into the side panels of the outer shell 120 for easy removal of the main reservoir 110 from the outer shell 120. Further details of the outer shell 120 are described in FIGS. 7 & 8.

The grow basket 130 is configured to hold a plant in growth medium and configured to sit on the main reservoir 110, i.e., placing the plant's roots in contact with fluid in the main reservoir. The grow basket 130 forms a container for holding a plant grown in growth medium. The growth medium may be rockwool, coconut coir, hydroton, perlite, pumice, gravel, soil, other material conducive to plant growth, or some combination thereof. The grow basket 130 may include one or more holes disposed towards a bottom of the grow basket 130. Roots of the plant may extend through the one or more holes into the main reservoir 110, i.e., when the grow basket 130 is coupled to the main reservoir 110. The grow basket 130 may include one or more structural features for coupling to the main reservoir 110. In one or more embodiments, the grow basket may include a basket top that is sized to be greater than a depth of the main reservoir 110. As such, the basket top can lay atop the top edge of the main reservoir 110 without the grow basket 130 falling into the reservoir. A basket portion of the grow basket 130, coupled to the basket top, may be configured to form the container holding the plant and the growth medium. In other embodiments, the grow basket 130 may include a clip, e.g., L-shaped protrusion from a top edge of the grow basket 130, configured to clip onto a vertical wall of the main reservoir 110, i.e., either the front wall, the back wall, or a side wall.

The grow basket 130 can be used to grow a variety of plants. For example, the grow basket 130 can be used for growing various edible herbs, including tuberous plants such as carrots and potatoes. By having individual baskets per plant, the growth medium in which the plants are planted is divided by the baskets. This makes it easy for the user to selectively remove plants, for example, if the user decides to grow another plant or if the growth medium is contaminated with disease, all without disruption of other grow baskets. The user can also grow a plant in one hydroponic system, then choose to migrate (or transplant) the plant to another hydroponic system with ease.

The inverted reservoirs 140 are configured to irrigate the main reservoir 110 and configured to sit on the main reservoir 110. Each inverted reservoir 140 includes a chamber for storing fluid, e.g., water, used in irrigating the main reservoir 110. Each inverted reservoir 140 also includes a spout, or other opening, used for filling the inverted reservoir 140 and for emptying the inverted reservoir 140 (e.g., for irrigating the main reservoir 110, or for cleaning). The physics of this water irrigation control mechanism is referred to as pressure equalization. The inverted reservoirs 140 are devoid of additional openings to prevent the entry of air. Consequently, water cannot continue its downward flow without external energy application, as it would otherwise lead to the formation of a vacuum. As the fluid in the main reservoir 110 is consumed by the plant or evaporated, the fluid line drops below the spout on the inverted reservoirs 140. Once the fluid line is below the spout, gravitational force causes fluid to outflow from the inverted reservoirs 140, overcoming any vacuum pressure in the container. Once the fluid reserves in the inverted reservoirs 140 are depleted, the plant can continue absorbing fluid (e.g., water) from the main reservoir 110. The fill line in the main reservoir 110 helps to maintain healthy levels of oxygenation of the plants in the one or more grow baskets 130.

In one or more embodiments, the inverted reservoirs 140 may include structural features for coupling to the main reservoir 110. In one or more embodiments, a depth of the inverted reservoir 140 may be greater than a depth of the main reservoir 110. As such, the inverted reservoir 140 may sit atop the top edge of the main reservoir 110. As the depth of the inverted reservoir 140 is tied to the depth of the main reservoir 110, the width and the height of the main reservoir 110 may be toggled to adjust a total volume of fluid that can be stored up by the inverted reservoir 140. A height of the spout of the inverted reservoir 140 can control the water fill line in the main reservoir 110. For example, a short spout (when the inverted reservoir 140 is in the inverted position and coupled to the main reservoir 110) would result in a higher fill line, at a higher point from the bottom surface of the main reservoir 110, compared to a taller spout which would result in a lower fill line at a lower point from the bottom surface of the main reservoir 110. The diameter of the spout controls irrigation rate, e.g., a larger spout outflows fluid faster than a smaller spout. In other embodiments, the inverted reservoir may include one or more clips for coupling to one or more verticals of the main reservoir 110. In other embodiments, the inverted reservoir is configured to function as a condensation collector and separator or a distiller. The inverted reservoir may comprise an opening configured to receive water vapor from a source (saltwater or contaminated water), such as a separate distillation chamber or from source water contained within the inverted reservoir itself. Internal surfaces of the inverted reservoir may function as condensation surfaces, facilitating the formation of condensation droplets. The inner surface of the inverted reservoir may be provided with geometric features such as plastic extensions, fins, ribs, or textured surfaces configured to increase the available surface area for condensation. Furthermore, the inner surface may be formed from or coated with a material selected to enhance condensation droplet formation and collection. The inverted reservoir is configured to collect these condensation droplets. A division (baffle or condensation canal) is located within the inverted reservoir to separate the collected condensed water from source water and can direct the condensed water to the main reservoir or directly to the plant substrate (such as sponge, cloth, rockwool, etc.). In configurations where the inverted reservoir contains the source water, it may also comprise a refill opening for introducing the source water into the inverted reservoir. In a circular configuration, the inverted reservoir and the main reservoir may be screwed together. Vents may be located on the inverted reservoir, configured to allow the ingress of outside air. This airflow is directed towards the main reservoir to facilitate convective heat dissipation. Further details of the distillation configuration are described in FIGS. 12-17.

In some embodiments, the chamber of the inverted reservoir 140 may be composed of a light-transmissive material, providing viewability of the fluid line of the inverted reservoir 140 by a user. In some embodiments, the inverted reservoir 140 may further include a metric scale, to provide an indication of water usage by the hydroponic system 100. In some embodiments, one or more walls of the chamber may be non-transmissive to light, to prevent heating of the fluid in the inverted reservoir 140 due to incident light. The inverted reservoir 140 may be used for storing water for irrigation of the main reservoir 110. In other embodiments, the inverted reservoir 140 may be used for storing other fluid-based nutrients. In some embodiments, the inverted reservoir 140 may include a valve or stop-gate for controlling or limiting outflow of fluid.

When the inverted reservoir 140 is coupled to the main reservoir 110, the inverted reservoir 140 is in an inverted position with the spout facing downwards. To operate an inverted reservoir 140, a user can decouple the inverted reservoir 140 from the main reservoir 110, un-invert the inverted reservoir 140 such that the spout is facing upwards and the inverted reservoir 140 is in an upright position, fill the inverted reservoir 140 with water in the upright position, then reinvert the inverted reservoir 140 while recoupling the inverted reservoir 140 to the main reservoir 110.

To operate the hydroponic system 100, a user fills the main reservoir 110 with fluid (e.g., water), e.g., to a fill line that is at a higher point (from the bottom surface of the main reservoir 110) than a lower portion of the grow basket 130. The user prepares the grow basket 130 by placing growth medium in the container of the grow basket 130 and placing a seed, a seedling, or a plant in the growth medium. The user couples the grow basket 130 to the main reservoir 110, e.g., placing the grow basket 130 on the top edge of the main reservoir 110. When coupled, a portion of the grow basket 130 is submerged in the fluid in the main reservoir 110, i.e., below the fill line. The user fills the inverted reservoirs 140 with fluid (e.g., water, or other fluid-based nutrients). The user inverts the inverted reservoir 140 while coupling the inverted reservoirs 140 atop the main reservoir 110.

FIG. 1B is a backside view of the hydroponic system 100 of FIG. 1A, according to one or more embodiments. As can be seen from the backside view, there is a small gap between the main reservoir 110 and the outer shell 120, when the main reservoir 110 is fitted into the outer shell 120. The small gap provides for air insulation between the outer shell 120 and the main reservoir 110, minimizing heat transfer from the outer shell 120 to the main reservoir 110.

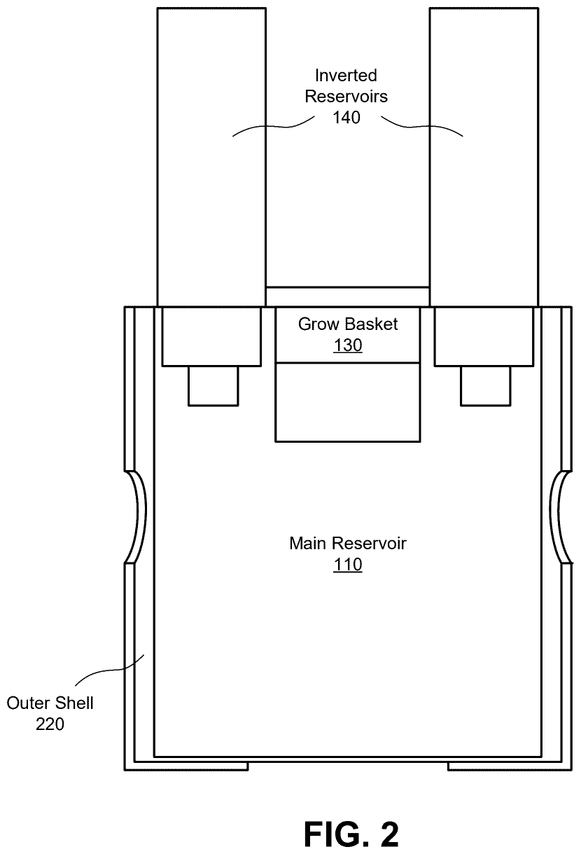

FIG. 2 is a backside view of a hydroponic system 200 with a half-sized outer shell 220, according to one or more embodiments. The hydroponic system 200 includes the main reservoir 110, the inverted reservoirs 140, and the grow basket 130. Here, the outer shell 220 is sized to be a similar height to the main reservoir 110. The outer shell 220 covers the front wall (on the opposite side when viewed from this backside view) and the side walls of the main reservoir 110. This half-sized shell permits more light in and around the grow basket 130, compared to the full-sized shell of the hydroponic system 100.

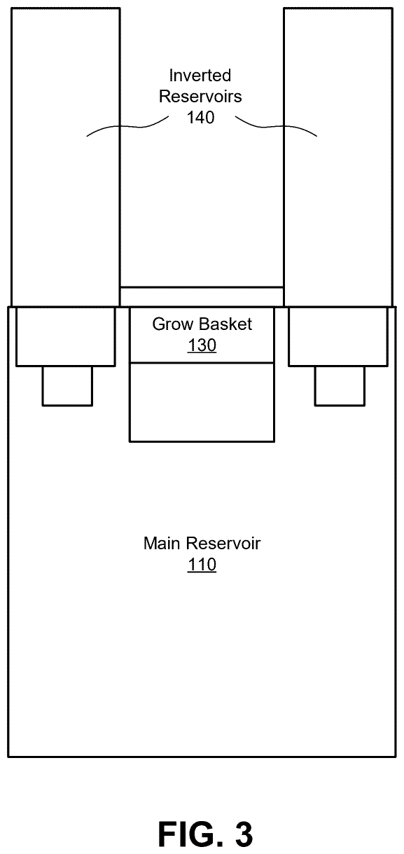

FIG. 3 is a backside view of a hydroponic system 300 without an outer shell, according to one or more embodiments. The hydroponic system 300 is devoid of the outer shell. In some embodiments, one or more vertical walls of the main reservoir 110 may be non-transmissive to light, e.g., for preventing algae growth in the main reservoir. In some embodiments, the one or more vertical walls of the main reservoir 110 are reflective of incident light, e.g., to prevent absorption of energy from the incident light, thereby heating the fluid in the main reservoir 110.

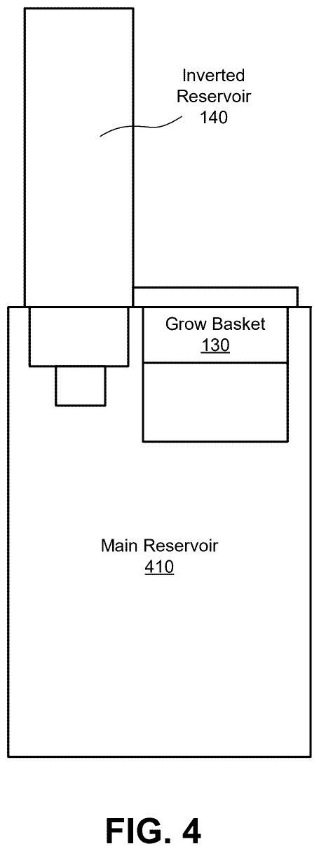

FIG. 4 is a backside view of a hydroponic system 400 with a single inverted reservoir 140, according to one or more embodiments. The hydroponic system 400 is sized to accommodate two units. As shown, the main reservoir 410 of the hydroponic system 400 is sized to include a single inverted reservoir 140 in conjunction with one grow basket 130. In another configuration, the hydroponic system 400 may include two grow baskets 130, hence the modularity of the hydroponic system 400. In other embodiments (not shown), an appropriately sized outer shell may be used to block light transmission to the fluid in the main reservoir 410, for preventing algae growth and/or for mitigating heat transfer.

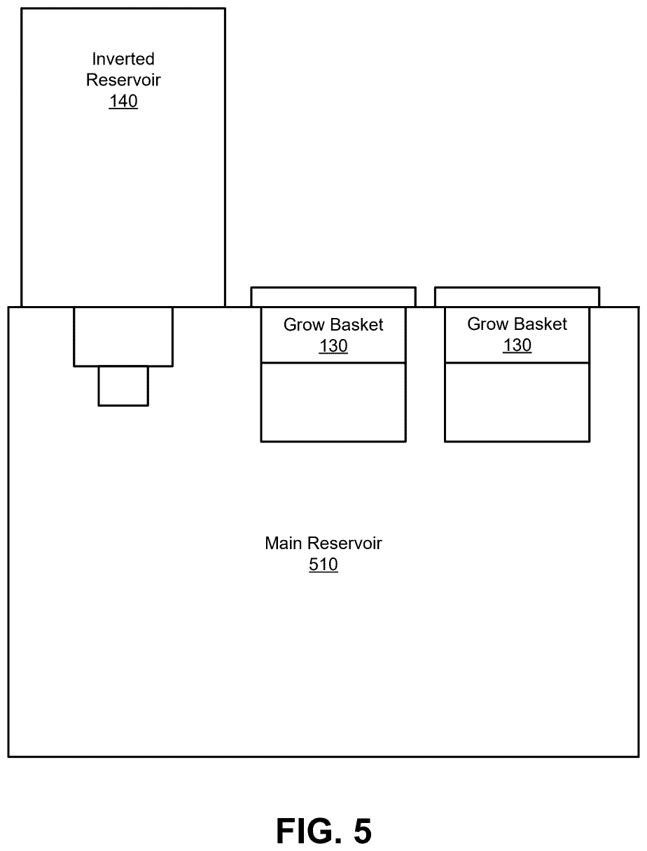

FIG. 5 is a backside view of a hydroponic system 500 with multiple grow baskets, according to one or more embodiments. The hydroponic system 500 is sized to accommodate three units. As shown, the main reservoir 510 of the hydroponic system 500 is sized to include a single inverted reservoir 140 in conjunction with two grow baskets 130. In another configuration, the hydroponic system 500 may include three grow baskets 130. In other embodiments (not shown), an appropriately sized outer shell (e.g., a half-sized or full-sized) may be used to block light transmission to the fluid in the main reservoir 410, for preventing algae growth and/or for mitigating heat transfer.

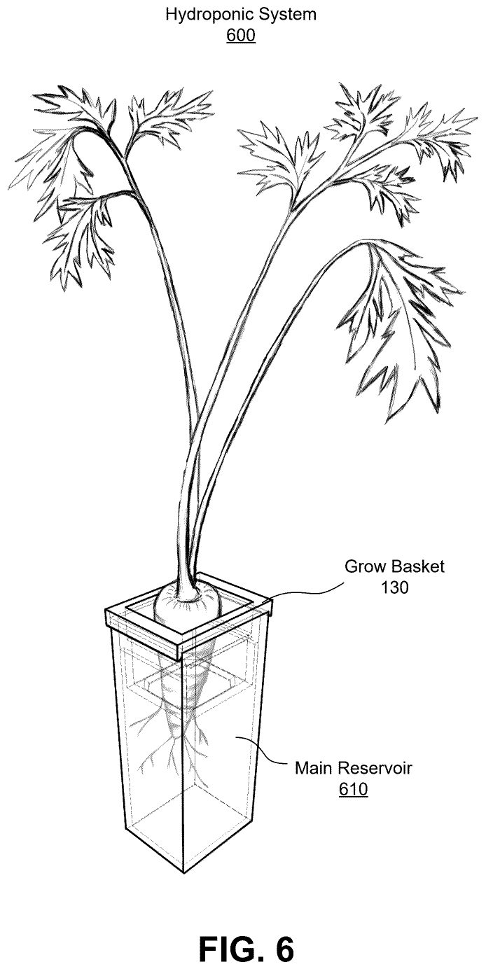

FIG. 6 is a perspective view of a hydroponic system 600 without an inverted reservoir, according to one or more embodiments. The hydroponic system 600 is sized to accommodate a single unit. As shown, the main reservoir 610 of the hydroponic system 600 is sized to include a single grow basket 130. This embodiment is devoid of the inverted reservoir 140. In other embodiments (not shown), an appropriately sized outer shell (e.g., half-sized or full-sized) may be used to block light transmission to the fluid in the main reservoir 610, for preventing algae growth and/or for mitigating heat transfer. The hydroponic system 600 may be used in growing tuberous plants, e.g., a carrot.

### Outer Shell Configuration

FIG. 7 is a backside perspective view of an outer shell 700, according to one or more embodiments. The outer shell 700 blocks light from contacting the main reservoir. The outer shell 700 may be formed by a base 710, two side panels 720, a front panel 730, and top panels 740. In other embodiments, the outer shell 700 may have an asymmetric design, e.g., with the front panel 730 extending along one side to provide light coverage for an inverted reservoir positioned on one side of the hydroponic system. The base 710 is sized to be bigger than the bottom wall of the main reservoir. The side panels 720 are connected to the base 710, extending vertically parallel. The front panel 730 is shaped with a bottom portion and two vertical extensions. The bottom portion is sized to occlude the main reservoir. The vertical extensions are sized to occlude inverted reservoirs coupled to the main reservoir. The top panels 740 connect to the side panels 720 and the front panel 730. The top panels 740 provide light protection of the inverted reservoirs from above.

The outer shell 700 may include other features. In one or more embodiments, the outer shell 700 may include grooves in the side panels 720 for easy gripping of the main reservoir, i.e., during removal of the main reservoir from the outer shell 700.

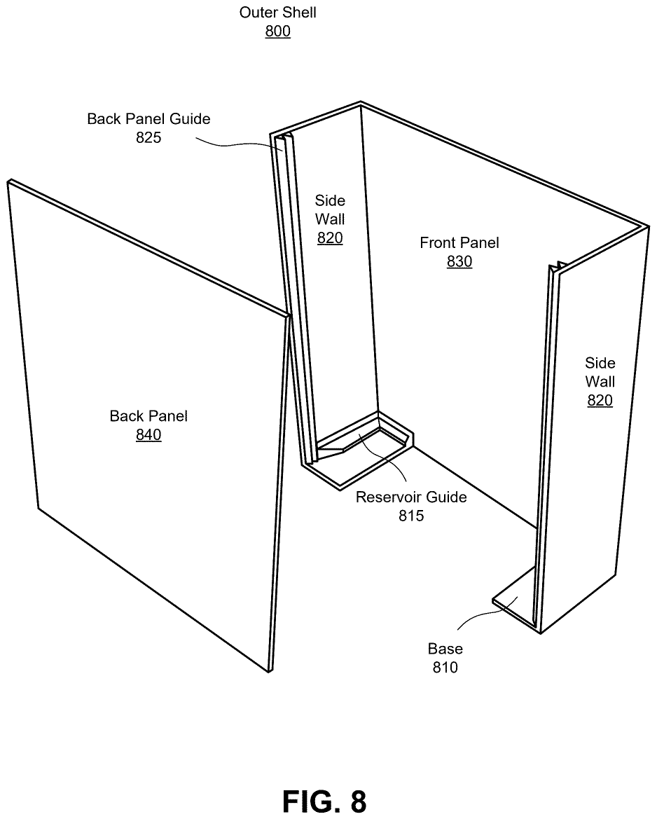

FIG. 8 is a backside perspective view of an outer shell 800 with a back panel 840, according to one or more embodiments. The outer shell 800, in these embodiments, is a half-sized shell. The outer shell 800 includes a base 810, two side panels 820, a front panel 830, and a back panel 840. The base 810, in the embodiments shown, may comprise two portions, each connected to either side panel 820. The front panel 830 is half-sized, only covering the main reservoir. In other embodiments, the front panel 830 may further include one or more extensions covering any inverted reservoirs. The back panel 840 couples to the side panels 820, opposite the front panel 830. Each side panel 820 includes a back panel guide 825 for securing the back panel 840. Each back panel guide 825 may include a vertical channel formed into the side panel 820, e.g., formed by two vertical supports. The vertical supports may be monolithically formed with the side panel 820. In other embodiments, the vertical supports may be composed of a different material than the side panel 820, e.g., the side panel 820 is composed of a thermoplastic (e.g., acrylic) with the back panel guide 825 composed of rubber or silicone. The back panel 840 slides into the back panel guides 825 on the two side panels 820, securing the back panel 840 to the side panels 820. The back panel 840 may be composed of a non-transmissive material, occluding the back side of the main reservoir from ambient light.

In this configuration, the user fits the main reservoir into the outer shell 800 with the back panel 840 detached or decoupled. Once the main reservoir is positioned within the base 810, the side panels 820, and the front panel 830, then the user can couple the back panel 840 to the side panels 820, e.g., by sliding the back panel down the back panel guides 825.

In one or more embodiments, the outer shell 800 further includes one or more reservoir guides 815. The reservoir guide 815 constrains a position of the main reservoir relative to the outer shell 800. One reservoir guide 815 may be coupled to one side panel 820, with a complementary reservoir guide 815 coupled to the other side panel 820. The reservoir guide 815 may be a protrusion from an inner surface of each respective side panel 820. In one or more embodiments, the reservoir guide 815 has an L-shape, constraining the lateral position and the forwardmost position of the main reservoir. The reservoir guides 815 may be coupled to portions of the front panel 830. In some embodiments, the reservoir guides 815 may be monolithically formed as part of the side panels 820 (and, optionally, the front panel 830). In other embodiments, the reservoir guides 815 may be formed of a different material and affixed to the side panels 820 (and, optionally, the front panel 830). As noted above, the main reservoir is slotted into the outer shell 800. As the user fits the main reservoir into the outer shell 800, the user can push the main reservoir to the foremost position against the portion of the reservoir guides 815 coupled to the front panel 830. The main reservoir may also be snug (i.e., a compression fit) between the lateral portions of the reservoir guides 815. Once the main reservoir is secured in the appropriate position, the user can slide the back panel 840 through the back panel guides 825.

### Inverted Reservoir Configuration

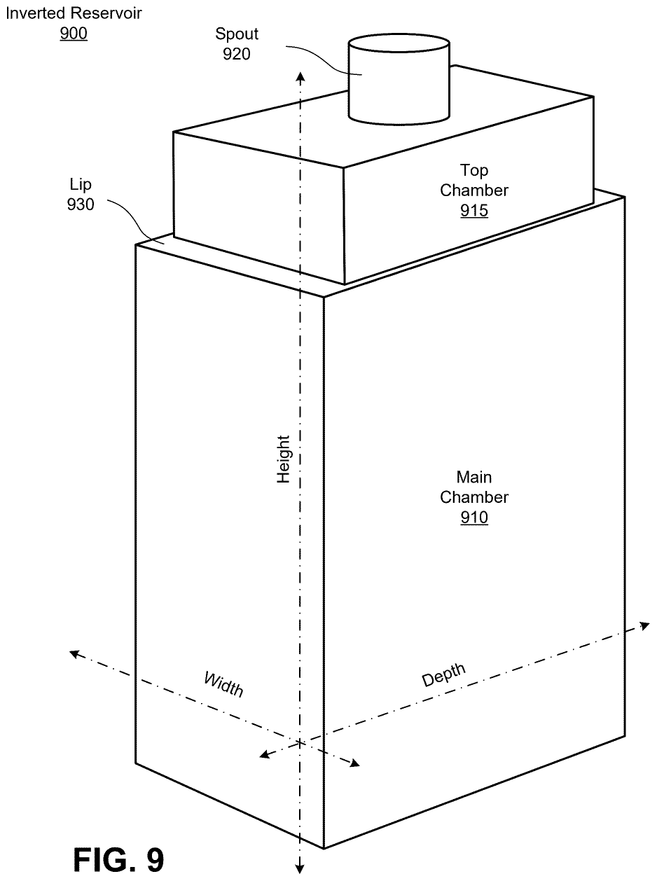

FIG. 9 is a close-up perspective view of an inverted reservoir 900 with spout upright, according to one or more embodiments. In one or more embodiments, the inverted reservoir 900 includes a main chamber 910 for storing fluid, a top chamber 915 for constraining a position of the inverted reservoir 900, and a spout 920 for inflow and outflow of fluid from the chamber 910. The inverted reservoir 900 may be shaped with a lip 930 at the interface between the main chamber 910 and the top chamber 915. The main chamber 910 has a depth that is greater than the depth of the main reservoir. The top chamber 915 has a depth at or less than the depth of the main reservoir. When coupled, the lip 930 rests on the top edge of the main reservoir. The top chamber 915 is positioned below the top edge of the main reservoir and may be a snug fit between the top chamber 915 and the main reservoir. The snug fit helps to constrain the depth-wise position of the inverted chamber 900. The opening of the spout 920 may be sized to provide ease of fluid flow in or out of the chamber 910. For example, the spout 920 may have an opening area of at least 0.5 cm², 1 cm², 2 cm², 3 cm², etc. The spout 920 may be cylindrical in shape, though other shapes may be implemented. The height of the spout 920 affects the fluid level in the main reservoir. A taller spout would cause fluid to draw out of the inverted reservoir 900 when the fluid level in the main reservoir depletes to a lower height, potentially leaving the plant in a grow basket out of contact from the fluid in the main reservoir. A lower spout would cause fluid to draw out of the inverted reservoir 900 when the fluid level depletes at a higher height, potentially leading to oversaturation of the plant in fluid.

### Grow Basket Configuration

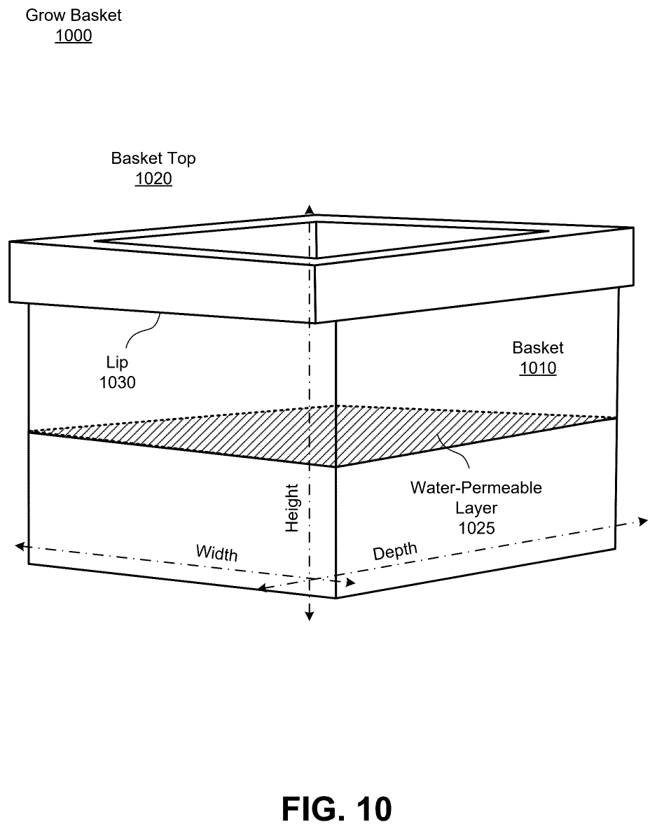

FIG. 10 is a close-up perspective view of a grow basket 1000, according to one or more embodiments. The grow basket 1000 includes a basket 1010 with a basket top 1020. The basket 1010 may have a depth at or less than the depth of the main reservoir. The basket top 1020 has a depth greater than the main reservoir. As such, the grow basket 1000 is coupled to the main reservoir with the basket top 1020 resting on the top edge of the main reservoir, while the basket 1010 descends into the main reservoir. The basket 1010 may include a water-permeable layer 1025 that helps to hold the growth medium in the basket 1010. The water-permeable layer 1025 is water permeable, i.e., water can diffuse through the water-permeable layer 1025. In some embodiments, the water-permeable layer 1025 is composed of woven material, e.g., material in a cross hatch pattern, woven plastic, woven fibers, etc. The water-permeable layer 1025 may further include one or more holes, through which roots may extend downward from the grow basket 1000 into the main reservoir. In some embodiments, the water-permeable layer 1025 may be positioned towards a bottom side of the grow basket 1000.

### Distillation Configuration

In some embodiments, the hydroponic system may include a distillation setup for distilling water from a non-potable water supply. The distilled water is collected in a receiver in fluid communication with the grow basket, thereby providing water to plants planted in the grow basket.

FIG. 12A is a side view of a modular hydroponic system 1200 with a distillation setup, according to one or more embodiments. FIG. 12B is a perspective view of the modular hydroponic system 1200 with the distillation setup of FIG. 12A, according to one or more embodiments.

The hydroponic system 1200 includes a distillation chamber 1210, a main reservoir 1220, a cooling reservoir 1230, a grow basket 1240, and two inverted reservoirs 1250. In other embodiments, the hydroponic system 1200 may include additional components (i.e., any other components described throughout this disclosure), fewer components (e.g., one inverted reservoir), different components, or some combination thereof.

The distillation chamber 1210 is configured to store source water for use in distillation, to supply distilled water to the grow basket 1240. The distillation chamber 1210, in the embodiment shown has a bottom receptacle for storing the source water (e.g., non-potable water, contaminated water, dirty water, etc.). In fluid communication with the bottom receptacle are two vapor channels 1212 that extend vertically from the bottom receptacle. Each vapor channel 1212 has an outlet positioned atop the vapor channel, for exhausting water vapor into the inverted reservoirs 1250. The distillation chamber 1210 further includes a bridge 1214 formed of two linear supports connecting the two vapor channels 1212. The main reservoir 1220 may be dimensioned and structured to rest on the bridge 1214. The distillation chamber 1210 may further include a port for introducing the source water into the distillation chamber 1210. In other embodiments, a user may pour source water through either outlet of the vapor channels 1212. In some embodiments, the distillation chamber 1210 includes one or more windows 1216 built into the vapor channels 1212 for passage of air horizontally. The flow of air would be perpendicular to the flow of water vapor, up the vapor channels 1212. The windows 1216 may maintain a seal in the vapor channel 1212, ensuring the water vapor is routed to the inverted reservoirs 1250.

A heat source may be coupled to the distillation chamber 1210 to transfer thermal energy into the source water, thereby causing evaporation of the water. In some embodiments, the heat source may be electric. In other embodiments, the distillation chamber 1210 is coated with a light-absorbing material (e.g., black paint). As light (e.g., sunlight) is incident upon the light-absorbing material, the light is absorbed and converted into thermal energy to heat the source water in the bottom receptacle of the distillation chamber 1210.

The main reservoir 1220 stores water for growing plants in the grow basket 1240. The main reservoir 1220 is an embodiment of other main reservoirs described throughout this disclosure. In one or more embodiments, the main reservoir 1220 includes a tapered shape moving from the top towards the bottom. Akin to the other main reservoirs described throughout this disclosure, the main reservoir 1220 is configured to hold water up to a fill line, to supply clean water to the grow basket 1240. The main reservoir 1220 holds up a receiver 1225 (e.g., at about the halfway height of the main reservoir 1220). The receiver 1225 is a receptacle for collecting distilled water, condensed in the inverted reservoirs 1250 and funneled down into the main reservoir 1220.

The cooling reservoir 1230 is coupled to the main reservoir 1220, and aids in cooling the main reservoir 1220. Principles of distillation generally leverage a temperature differential in the distillation setup. At the start of the water path, a higher temperature at the bottom receptacle of the distillation chamber 1210 causes the source water to evaporate into water vapor. A cooler temperature at the inverted reservoirs 1250 causes the water vapor to condense into the distilled water. The distilled water then is funneled into the main reservoir 1220, or more specifically the receiver 1225 of the main reservoir 1220. When the main reservoir 1220 is depleted of water, water vapor will fill the main reservoir 1220, and heat will transfer to its walls. The cooling reservoir 1230 can be filled with any source of water (e.g., saltwater), allowing heat to transfer from the main reservoir 1220 into the water in the cooling reservoir 1230. The open top of the cooling reservoir 1230 will allow vapor to escape, thereby reducing the water temperature and, in turn, cooling the walls of the main reservoir 1220, which promotes condensation inside it. The cooling reservoir 1230 can also be filled with a cold substance, e.g., cold water, ice, cooled rocks, etc., thereby enhancing the temperature differential driving the water distillation. An electric fan can also be attached to the main reservoir 1220 or to the cooling reservoir 1230, thereby reducing the reservoir temperature and promoting condensation in the main reservoir 1220. The cooling reservoir can be integrated into the main reservoir by gluing parts together, or it can be formed as a single piece using 3D printing or other molding or assembly techniques. Alternatively, it can be designed to be attachable or detachable from the main reservoir.

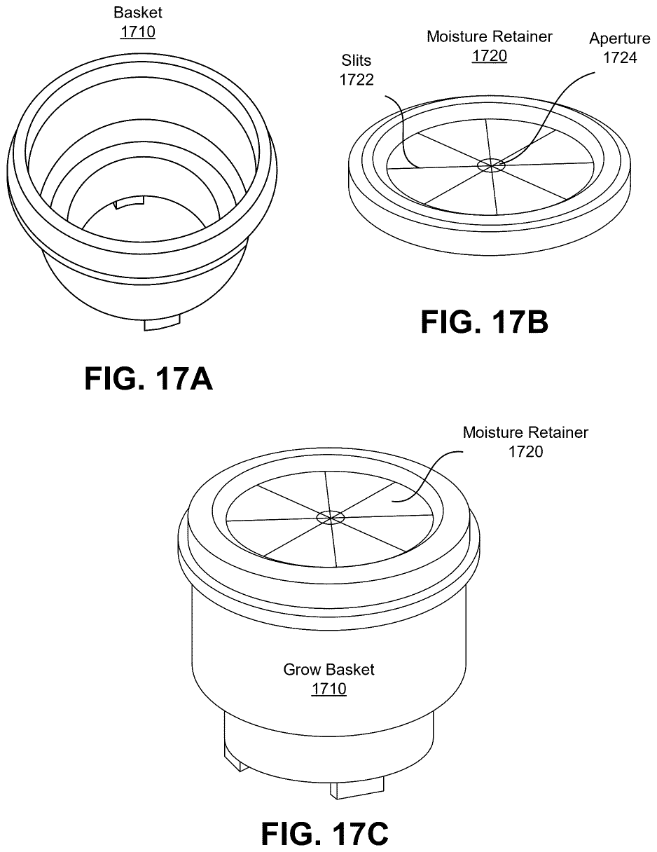

The grow basket 1240 houses a plant grown in the hydroponic system 1200. The grow basket 1240 generally includes a receptacle that can hold a growth medium. A plant is affixed to the growth medium. Roots of the plant can extend below a bottom opening of the grow basket 1240. The grow basket 1240 may be an embodiment of the grow basket 130, or the grow basket 1000. In one or more embodiments, the grow basket 1240 may include a moisture retainer fitted on the top of the grow basket 1240. The moisture retainer may be formed by a waterproof material, e.g., silicone, plastic, rubber, etc. In one or more embodiments, the moisture retainer is formed by a flexible material. Additional description of the moisture retainer is below, described in conjunction with FIGS. 17A-17C.

The inverted reservoirs 1250 are receptacles coupled to the vapor channels 1212 of the distillation chamber 1210 for condensing water vapor into distilled water. In one or more embodiments, each inverted reservoir 1250 includes two openings. A first opening is the spout that descends into the main reservoir 1220. A second opening is a port, through which the water vapor from the vapor channels 1212 enter the inverted reservoir 1250. In one or more embodiments, the openings are positioned at different heights, with the first opening positioned at a lower height than the second opening, when the inverted reservoir 1250 is in the inverted position. The slanted surface from the second opening to the first opening funnels the condensate towards the first opening, such that the condensate drips on the receiver 1225.

To operate the hydroponic system 1200, a user assembles the hydroponic system 1200. In one or more embodiments, assembly includes affixing the main reservoir 1220 to the distillation chamber 1210, i.e., via the bridge 1214. Assembly may also entail inversion of the inverted reservoirs 1250 and placement of the inverted reservoirs 1250 atop the vapor channels 1212 of the distillation chamber 1210 and a top edge of the main reservoir 1220, with the spout extending downwards into an internal volume of the main reservoir 1220. Assembly may further entail placement of a growth medium into the grow basket 1240, optionally affixing the moisture retainer to the top of the grow basket 1240, and affixing the grow basket 1240 atop the top edge of the main reservoir 1220. To supply fluid, the user can pour clean water into the main reservoir 1220, e.g., up to a fill line. The user can further add the water or a cold substance to the cooling reservoir 1230. The user can fill the distillation chamber 1210 with source water as a source of the distillation setup. The source water can be non-potable water, e.g., dirty water, unfiltered water, etc. As the source water is distilled, the water is collected in the receiver 1225, which is positioned below the bottom of the grow basket 1240.

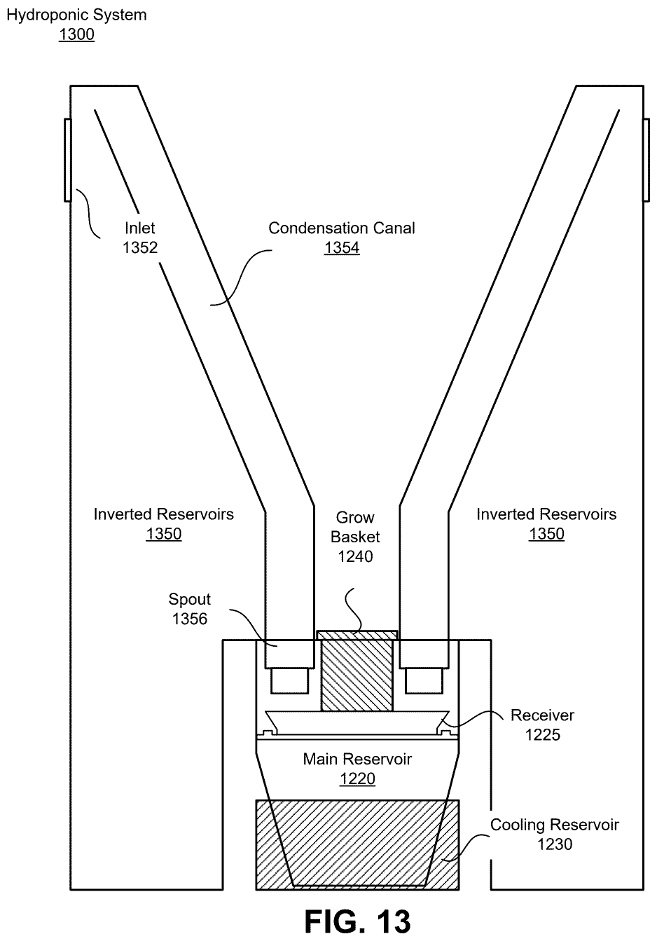

FIG. 13 is a side view of a modular hydroponic system 1300 with a distillation setup, according to one or more embodiments. The modular hydroponic system 1300 is an embodiment of the modular hydroponic system 1200. In this embodiment, the modular hydroponic system 1300 has two inverted reservoirs 1350 sized to rest on a planar surface adjacent to the main reservoir 1220 and the cooling reservoir 1230. There is also no distillation chamber.

In this embodiment, the inverted reservoirs 1350 have a receptacle for storage of source water, and condensation canals 1354 for funneling condensate towards the main reservoir 1220 and the receiver 1225. Each inverted reservoir 1350 includes a bottom receptacle for storing source water. Each inverted reservoir 1350 includes an inlet 1352, which is an opening for supplying the source water to the inverted reservoir 1350. Here, the inlet 1352 is positioned on one side of the inverted reservoir 1350, opposite a side of the condensation canal 1354. The inlet 1352 may include a cap to seal the inlet 1352, so as to prevent leakage of the water vapor out the inlet 1352. The top portion of the inverted reservoir 1350 (above the bottom receptacle) has a pentagonal-prism shape. The condensation canal 354 on the inner side of the inverted reservoir, i.e., facing the grow basket 1240, is formed of a slanted portion and a vertical portion. As water vapor condenses near the top of the inverted reservoir 1350 (in the inverted position), the condensate drips down the slanted portion, down the vertical portion, through the spout of the inverted reservoir 1350, and onto the receiver 1225. In the embodiment shown, the bottom receptacle of the inverted reservoir 1350 is of a similar height to the main reservoir 1220.

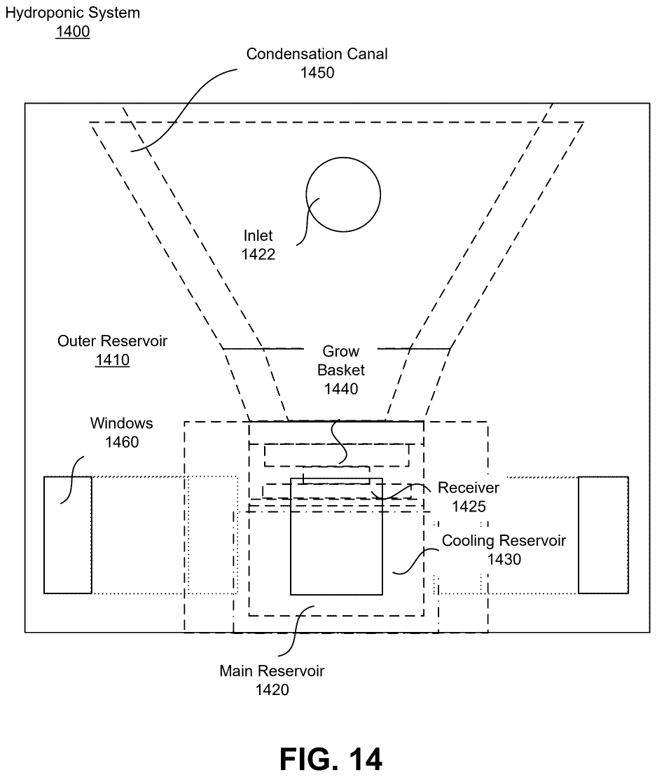

FIG. 14 is a side view of a modular hydroponic system 1400 with a distillation setup, according to one or more embodiments. In this embodiment, the modular hydroponic system 1400 has an outer reservoir 1410 for distillation of water to be supplied to the main reservoir 1420. The grow basket 1440 is coupled to the main reservoir 1420, drawing water from the main reservoir 1420, or the receiver 1425. The outer reservoir 1410 operates on similar principles to the inverted reservoirs 1350 of the hydroponic system 1300 of FIG. 13.

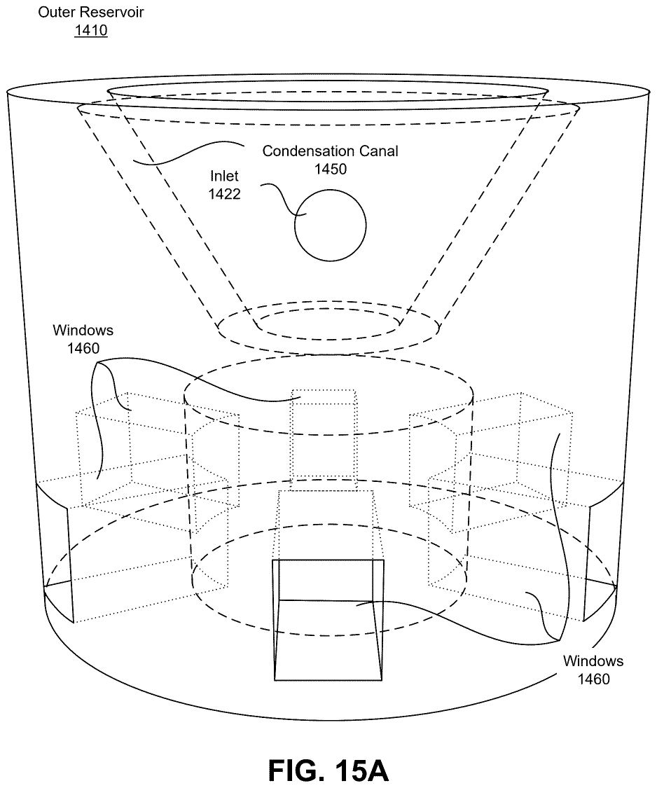

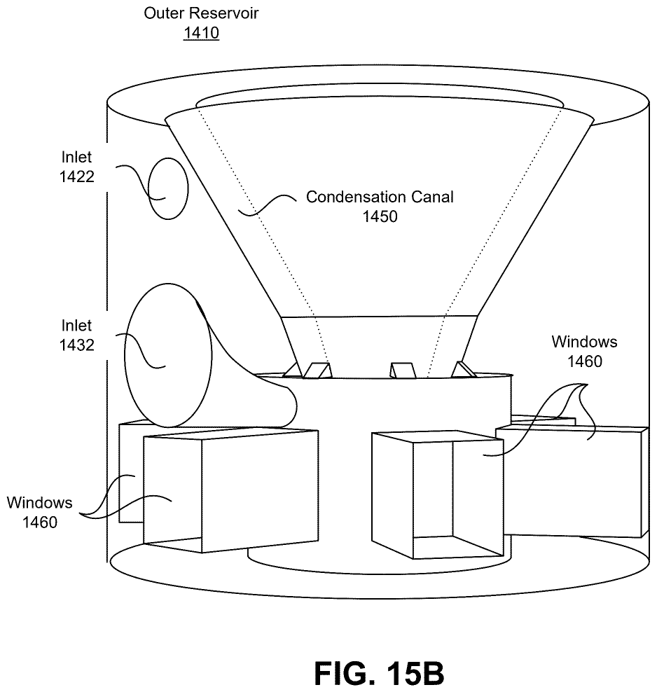

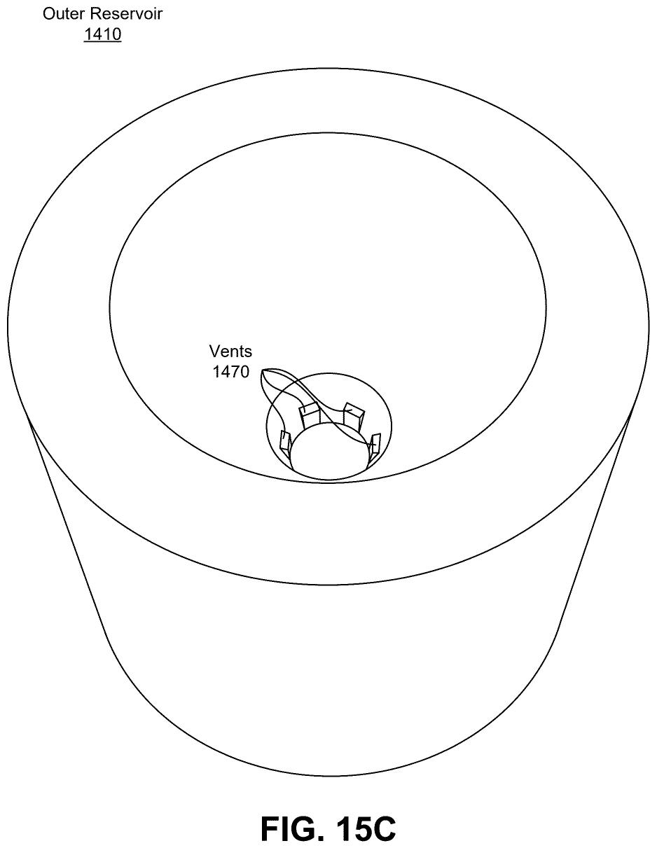

The outer reservoir 1410 distills water and supplies the water to the main reservoir 1420. The outer reservoir 1410 is cylindrical in shape. FIG. 15A is a perspective view of the outer reservoir 1410 for the modular hydroponic system of FIG. 14, according to one or more embodiments. FIG. 15B is a side view of the outer reservoir 1410 of FIG. 15A, according to one or more embodiments. The inner surface of the outer reservoir 1410 has a conical section above a cylindrical section. The conical section of the outer reservoir 1410 is similar to the slanted portion of the inverted reservoir 1350 of the hydroponic system 1300 of FIG. 13. The outer reservoir 1410 includes an annular base and an annular top. The outer reservoir 1410 also includes an inlet 1422 for supplying source water to the outer reservoir 1410. The inlet 1422 is an opening positioned above a halfway height of the outer reservoir 1410. The inlet 1422 may also include a lid or a cap for sealing the inlet 1422, thereby preventing leakage of water vapor. The condensation canal 1450 has a funnel shape, including a top wide conical portion and a bottom narrow conical portion. Similar in operation to the inverted reservoir 1350, as the source water is evaporated forming water vapor that rises to a top of the outer reservoir 1410, the water vapor condensates and drips down the condensation canal 1450 to the main reservoir 1420. In some embodiments, the outer reservoir 1410 further includes an inlet 1432 connected to a conduit to the cooling reservoir 1430. The conduit through the outer reservoir 1410 is not in fluidic communication with the receptacle of the outer reservoir 1410. Its primary function is to allow water to pass through the outer reservoir 1410 and into the cooling reservoir 1430. This enables the user to refill the cooling reservoir 1430 without removing the outer reservoir 1410 from the main reservoir 1420 and the cooling reservoir 1430.

In some embodiments, the outer reservoir 1410 further includes one or more windows 1460 for passage of air. The one or more windows 1460 are not in fluidic communication with the receptacle of the outer reservoir 1410. The one or more windows 1460 provide fluidic communication between an external environment of the outer reservoir 1410 and an internal environment, where the main reservoir 1420 is coupled to the outer reservoir 1410. In one or more embodiments, the windows are radially disposed around the lower half of the outer reservoir 1410. In the embodiment shown in FIGS. 14, 15A, and 15B, there are six windows 1460 distributed equiradially (i.e., every 60 degrees) about the outer reservoir 1410.

FIG. 15C is a top perspective view of the outer reservoir 1410 of FIG. 15A, according to one or more embodiments. The outer reservoir 1410 may include a plurality of vents 1470 for venting air from the internal environment. In the embodiment shown in FIG. 15C, there are six vents 1470 distributed equiradially (i.e., every 60 degrees) on an external surface of the condensation canal 1450.

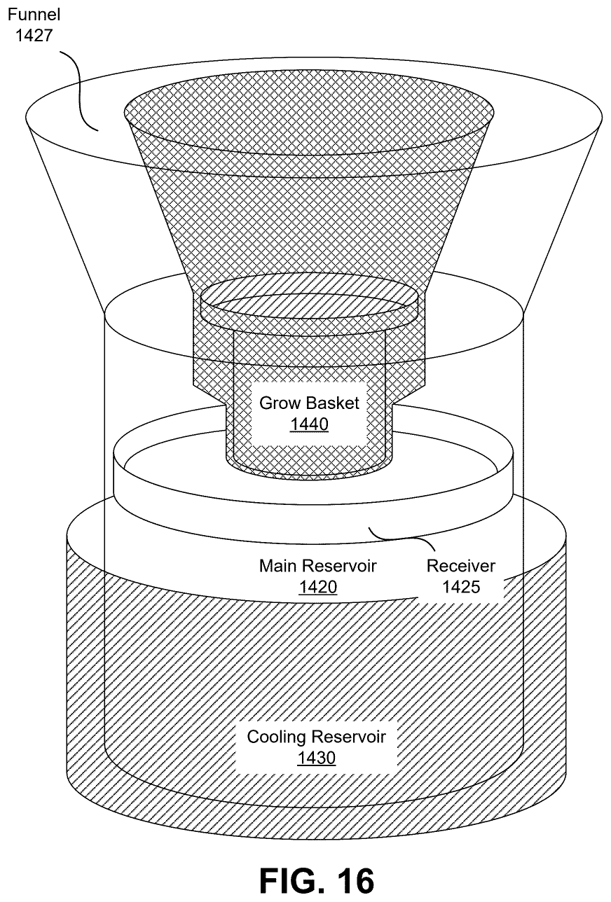

FIG. 16 is a perspective view of the main reservoir 1420 for the modular hydroponic system 1400 of FIG. 14, according to one or more embodiments. The main reservoir 1420 includes a receptacle of holding clean water for watering the grow basket 1440. The main reservoir 1420 is cylindrical in shape, sized to fit in the internal environment of the outer reservoir 1410. The main reservoir 1420 includes the receiver 1425 positioned around the halfway height of the main reservoir 1420. The receiver 1425 is also positioned below the grow basket 1440, such that roots extending below the grow basket 1440 would be in contact with the receiver 1425. The receiver 1425 may also be annular, with a central opening that allows roots to pass downward into the main reservoir 1420. This design enables common fibrous roots to access both the lower water levels and the water condensed in the receiver 1425, while also allowing the development of tuberous roots to extend downward. The main reservoir 1420 may be attached to the outer reservoir 1410 via a funnel 1427 with an annular top that complements the annular bottom of the condensation canal 1450 of the outer reservoir 1410. The main reservoir 1420 may be integrated with the funnel 1427 or detachable by being screwed into it. Similarly, the funnel 1427 may be either integrated into the outer reservoir 1410 or detachable by being screwed into it.

The cooling reservoir 1430 is also cylindrical in shape, with a diameter greater than the bottom receptacle of the main reservoir 1420. The cooling reservoir 1430 is an embodiment of the cooling reservoir 1230. The cooling reservoir 1430 stores water or a cold substance for cooling the main reservoir 1420, e.g., cold water, ice, etc.

FIG. 17A is a top perspective view of a circular grow basket 1710, according to one or more embodiments. The grow basket 1710 is cylindrical in shape. The grow basket 1710 may include one or more radial support structures positioned at a bottom of the grow basket 1710. The support structures can hold growth medium placed into the grow basket 1710.

FIG. 17B is a top perspective view of a moisture retainer 1720 couplable to a top of the circular grow basket 1710, according to one or more embodiments. The moisture retainer 1720 retains moisture in the grow basket 1710, while including an aperture 1724 for sprouts to extend upwards. The aperture 1724 is positioned in a middle of the moisture retainer 1720. The moisture retainer 1720 may further include one or more radial slits 1722, permitting the aperture 1724 to increase in size for the growing plant. In some embodiments, the moisture retainer 1720 is formed of a flexible and waterproof material, e.g., silicone. The moisture retainer 1720 can be compression fit atop the basket 1710.

FIG. 17C is a top perspective view of the circular grow basket 1710 with the moisture retainer 1720 coupled atop, according to one or more embodiments.

### Manufacturing System

In one or more embodiments, a manufacturing system manufactures one or more components of the hydroponic system. The manufacturing system may include a 3D printer for forming plastic structures. The 3D printer includes a build box, a recoating system, and a printing mechanism. The build box is a container holding the structure as the print material is extruded onto a platform of the build box. In implementations with thermoplastics, the print material may be a spool of plastic filament that is fed into a nozzle that melts the filament when extruding onto the platform. A control system manages the movement of the nozzle, for accurate and precise deposition of the print material. In one or more embodiments, the manufacturing system may form each component as a monolithic structure. For example: the 3D printer may print the main reservoir as a single monolithic structure; each inverted reservoir as a single monolithic structure; each grow basket as a single monolithic structure; and the outer shell as a single monolithic structure. In other embodiments, the 3D printer may print pieces for a component, with another device for fusing the pieces to form the component.

In one or more example implementations, the manufacturing system includes a spray-on coating system. The spray-on coating system may be used for spraying on material onto components. The spray-on coating system includes a material supply system, a mixing unit, a spray nozzle, an air compressor, and a control system. The material supply system, which may include one or more containers and one or more pumps, stores and delivers the liquid material, which may often be in a two-part formulation that is mixed just prior to application. The mixing unit ensures proper homogenization of the material. The spray nozzle disperses the mixed material, e.g., by atomizing the liquid into a fine spray. The air compressor or other propellant system provides the pressure to atomize and propel the liquid material through the spray nozzle. The control system manages the material flow rate, air pressure, and spray pattern to achieve the desired coating thickness and uniformity. The spray-on coating system may continue to deposit liquid material, layer by layer, to achieve the desired thickness. In some embodiments, the spray-on coating system may be used to deposit a layer onto one or more of the components of the hydroponic system. For example, the spray-on coating system may spray on a non-transmissive material onto the outer shell, giving the outer shell the non-transmissive characteristic.

One or more systems of the manufacturing system may be controlled by a computer system. The computer system may control movement and operation of the systems. With the example of 3D printing, the computer system may generate a design for the various components. To print those components, the computer system may generate printing instructions based on the design, to optimize manufacturing of the components.

### Example Implementations

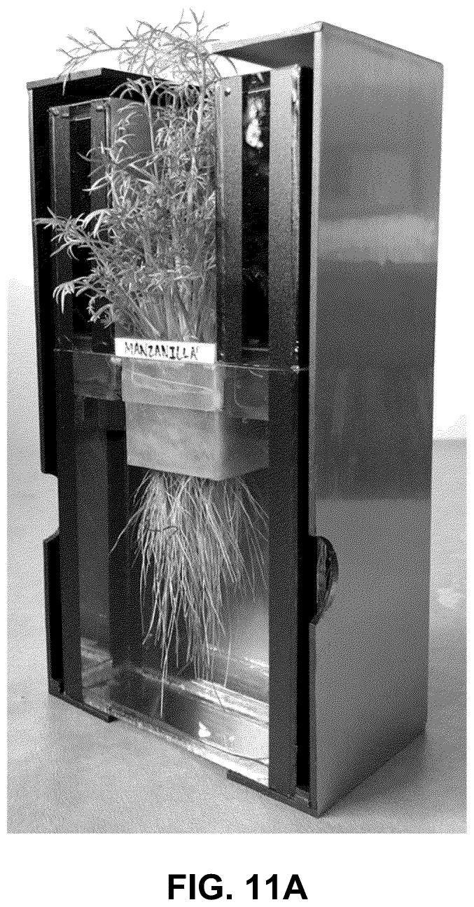

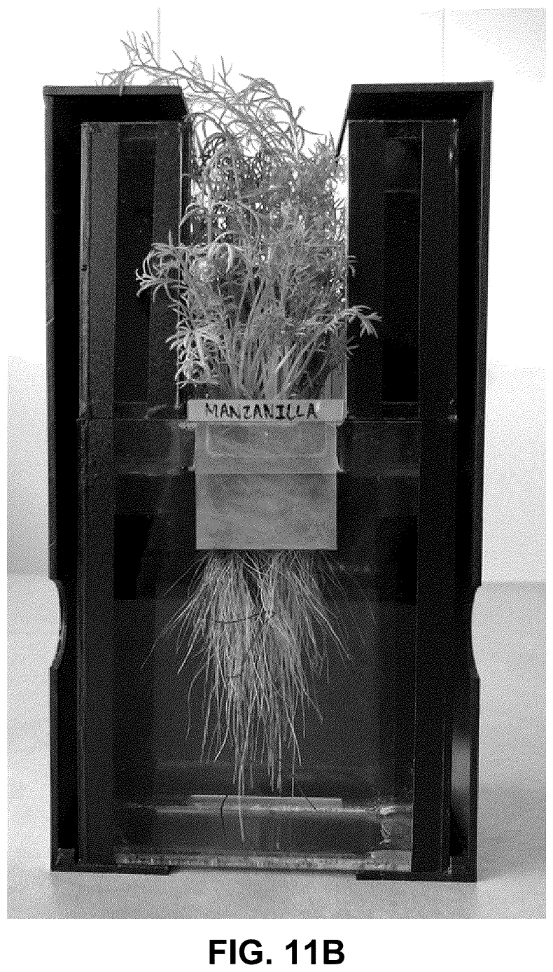

FIG. 11A is a first image of the hydroponic system of FIGS. 1A & 1B, according to one or more example implementations. FIG. 11B is a second image of the hydroponic system of FIGS. 1A & 1B, according to one or more example implementations. The hydroponic system includes the two inverted reservoirs flanking a grow basket planted with chamomile plant (“manzanilla”).

Clause 1. A hydroponic system comprising: a main reservoir configured to store fluid for supporting plant growth; a basket comprising: a top portion configured to rest on a top edge of the main reservoir, and a bottom portion coupled to the top portion and configured to extend into the main reservoir below a fluid fill line of the main reservoir; and an inverted reservoir comprising: a chamber configured to store reserve fluid and configured to rest on the top edge of the main reservoir, and a spout disposed on the chamber for fluid access to the chamber, wherein the spout descends into the main reservoir when the inverted reservoir is in an inverted position with the spout facing downwards, wherein an outermost opening of the spout defines the fill line of the main reservoir.

Clause 2. The hydroponic system of clause 1, further comprising: an outer shell composed of a non-transmissive material and sized to fit at least the main reservoir, wherein the outer shell blocks ambient light on the main reservoir from one or more directions.

Clause 3. The hydroponic system of clause 2, the outer shell comprising: a base; two side panels connected to opposite sides of the base; and a front panel connected to the base and the two side panels.

Clause 4. The hydroponic system of clause 3, each side panel of the outer shell comprising a groove for gripping the main reservoir during decoupling from the outer shell.

Clause 5. The hydroponic system of clause 3, each side panel of the outer shell comprising a protrusion from an inner surface of each side panel configured to constrain a position of the main reservoir when coupled to the outer shell.

Clause 6. The hydroponic system of clause 3, each side panel of the outer shell comprising a channel disposed on an inner surface of each side panel, the outer shell further comprising: a back panel couplable to the side walls via the channels, the back panel parallel to the front panel of the outer shell.

Clause 7. The hydroponic system of clause 3, the front panel comprising: a bottom portion sized to cover the main reservoir; and a top portion extending vertically from the bottom portion of the front panel and sized to cover the inverted reservoir.

Clause 8. The hydroponic system of clause 7, the outer shell further comprising: a top panel connected to the side panel and the top portion of the front panel, the top panel parallel to the base of the outer shell.

Clause 9. The hydroponic system of clause 2, wherein the outer shell is composed of a reflective material.

Clause 10. The hydroponic system of clause 1, the top portion of the basket having a depth greater than a depth of the main reservoir, and the bottom portion of the basket having a depth less than the depth of the main reservoir.

Clause 11. The hydroponic system of clause 1, the top portion of the basket comprising a clip for coupling the top portion of the basket to a vertical wall of the main reservoir.

Clause 12. The hydroponic system of clause 1 the top portion of the basket forming an opening to the bottom portion of the basket, and the bottom portion of the basket comprising a water-permeable layer.

Clause 13. The hydroponic system of clause 1, the bottom portion of the basket comprising a water-permeable layer configured to hold growth medium and a plant planted in the growth medium and configured to diffuse water from the main reservoir through the water-permeable layer.

Clause 14. The hydroponic system of clause 13, wherein the water-permeable layer is composed of woven material.

Clause 15. The hydroponic system of clause 13, the water-permeable layer comprising one or more holes configured for root growth through the water-permeable layer.

Clause 16. The hydroponic system of clause 1, the chamber of the inverted reservoir comprising: a main chamber having a depth greater than a depth of the main reservoir; and a top chamber coupled to the main chamber and having a depth less than the depth of the main reservoir, wherein the spout is disposed on the top chamber.

Clause 17. The hydroponic system of clause 1, the spout of the inverted reservoir comprising: a valve for controlling outflow of fluid from the chamber of the inverted reservoir.

Clause 18. The hydroponic system of clause 1, where the main reservoir or the chamber of the inverted reservoir is formed of transmissive material.

Clause 19. The hydroponic system of clause 1, wherein the basket or the inverted reservoir is removably couplable to the main reservoir.

Clause 20. The hydroponic system of claim 1, further comprising: a distillation chamber comprising: a bottom receptacle to hold source water for use in distillation; and a condensation canal coupled to a top of the bottom receptacle, wherein the condensation canal includes one or more slanted surfaces for funneling distilled water into the main reservoir.

Clause 21. The hydroponic system of clause 1, further comprising: a second basket coupled to the main reservoir, or a second inverted reservoir coupled to the main reservoir.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more subprocessing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A hydroponic system comprising:
a main reservoir configured to store fluid for supporting plant growth;
a basket comprising:
a top basket portion configured to rest on a top edge of the main reservoir, and
a bottom basket portion coupled to the top basket portion and configured to extend into the main reservoir below a fluid fill line of the main reservoir; and
an inverted reservoir comprising:
a chamber configured to store reserve fluid and configured to rest on the top edge of the main reservoir, and
a spout disposed on the chamber for fluid access to the chamber, wherein the spout does not comprise a valve, wherein the spout descends into the main reservoir when the inverted reservoir is in an inverted position with the spout facing downwards, wherein an outermost opening of the spout defines the fill line of the main reservoir to be below the top basket portion when the basket is coupled to the main reservoir, thereby creating an air chamber for oxygenation of roots in the basket.

2. The hydroponic system of claim 1, further comprising:
an outer shell composed of a non-light-transmissive material and sized to fit at least the main reservoir, wherein the outer shell blocks ambient light on the main reservoir from one or more directions.

3. The hydroponic system of claim 2, the outer shell comprising:
a base;
two side panels connected to opposite sides of the base; and
a front panel connected to the base and the two side panels.

4. The hydroponic system of claim 3, each side panel of the outer shell comprising a groove for gripping the main reservoir during decoupling from the outer shell.

5. The hydroponic system of claim 3, each side panel of the outer shell comprising a protrusion from an inner surface of each side panel configured to constrain a position of the main reservoir when coupled to the outer shell such that there is an air gap between the front panel of the outer shell and the main reservoir to insulate the main reservoir.

6. The hydroponic system of claim 3, each side panel of the outer shell comprising a channel disposed vertically on an inner surface of each side panel, the outer shell further comprising:
a back panel slidably couplable to the side walls via the channels disposed vertically, the back panel parallel to the front panel of the outer shell.

7. The hydroponic system of claim 3, the front panel comprising:
a bottom panel portion sized to cover the main reservoir; and
a top panel portion extending vertically from the bottom panel portion of the front panel and sized to cover the inverted reservoir.

8. The hydroponic system of claim 7, the outer shell further comprising:
a top panel connected to the side panel and the top panel portion of the front panel, the top panel parallel to the base of the outer shell.

9. The hydroponic system of claim 2, wherein the outer shell is composed of a reflective material.

10. The hydroponic system of claim 1, the top basket portion of the basket having a depth greater than a depth of the main reservoir, and the bottom basket portion of the basket having a depth less than the depth of the main reservoir.

11. The hydroponic system of claim 1, the top basket portion of the basket comprising a clip for coupling the top basket portion of the basket to a vertical wall of the main reservoir.

12. The hydroponic system of claim 1 the top basket portion of the basket forming an opening to the bottom basket portion of the basket, and the bottom basket portion of the basket comprising a water-permeable layer.

13. The hydroponic system of claim 1, the bottom basket portion of the basket comprising a water-permeable layer configured to hold growth medium and a plant planted in the growth medium and configured to diffuse water from the main reservoir through the water-permeable layer.

14. The hydroponic system of claim 13, wherein the water-permeable layer is composed of woven material.

15. The hydroponic system of claim 13, the water-permeable layer comprising one or more holes configured for root growth through the water-permeable layer.

16. The hydroponic system of claim 1, the chamber of the inverted reservoir comprising:
a main chamber having a depth greater than a depth of the main reservoir; and
a top chamber coupled to the main chamber and having a depth less than the depth of the main reservoir, wherein the spout is disposed on the top chamber.

17. (canceled)

18. The hydroponic system of claim 1, where the main reservoir or the chamber of the inverted reservoir is formed of light-transmissive material.

19. The hydroponic system of claim 1, wherein the basket or the inverted reservoir is removably couplable to the main reservoir, and wherein a position of the basket and a position of the inverted reservoir is unfixed along the main reservoir.

20. The hydroponic system of claim 1, further comprising:
a distillation chamber comprising:
a bottom receptacle to hold source water for use in distillation; and
a condensation canal coupled to a top of the bottom receptacle, wherein the condensation canal includes one or more slanted surfaces for funneling distilled water into the main reservoir.

21. The hydroponic system of claim 20, wherein the condensation canal of the distillation chamber is removably coupled to top edge of the main reservoir, wherein water vapor is configured to condense at the top of the bottom receptacle and configured to drip to the condensation channel.
